(19) United States
(12) Patent Application Publication
(10) Pub. No.: US 2020/0127523 A1
(43) Pub. Date: Apr. 23, 2020

(54) Rotary Electric Machine

(71) Applicant: Hitachi Automotive Systems, Ltd., Hitachinaka-shi, Ibaraki (JP)

(72) Inventors: Akihito TOYA, Hitachinaka (JP); Masahiro HOSOYA, Hitachinaka (JP)

(21) Appl. No.: 16/625,844

(22) PCT Filed: May 15, 2018
(86) PCT No.: PCT/JP2018/018656

§ 371 Date: Dec. 23, 2019

(30) Foreign Application Priority Data
Jun. 26, 2017 (JP) 2017-124327

(51) Int. Cl. H02K 3/48; H02K 1/16; H02K 3/12

(52) U.S. Cl. CPC H02K 3/48; H02K 3/12; H02K 1/16

(57) ABSTRACT

Provided is a rotary electric machine which achieves miniaturization and high power while preventing winding break of a coil. A rotary electric machine includes a stator which includes a stator core, a bobbin attached to the stator core, and a coil wound around a winding portion of the bobbin to generate a magnetomotive force, and a rotor provided on an inner peripheral side of the stator. The winding portion includes a regulation portion in an end surface in an axial direction of a rotation shaft of the rotary electric machine to regulate a position of the coil wound around the winding portion.

### TECHNICAL FIELD

The present invention relates to a rotary electric machine, and particularly to a structure of a bobbin where a coil is wound.

### BACKGROUND ART

Conventionally, as a structure of a rotary electric machine, there is known a structure in which a bobbin is attached to a stator core, and a coil is wound around the bobbin. In such a structure, when the coil is wound around the bobbin, it is desirable that the coil is wound without causing winding break in order to secure reliability of the rotary electric machine.

For example, in a disclosure of JP 2008-148515 A, a projection protruding in a circumferential direction with respect to a rotation shaft of the rotary electric machine is provided in the bobbin, and the coil is wound along the projection, so that the winding break of the coil is prevented.

### CITATION LIST

### Patent Literature

PTL 1: JP 2008-148515 A

### SUMMARY OF INVENTION

### Technical Problem

However, in the disclosure of JP 2008-148515 A, the projection protrudes in the circumferential direction, that is, protruding to narrow a slot in the circumferential direction. Therefore, a coil space in the slot is reduced. Then, in order to secure the coil space, the rotary electric machine is necessarily increased in size, and the output power of the rotary electric machine is lowered if the coil space is reduced.

An object of the invention is to provide a rotary electric machine which achieves miniaturization and high power while preventing the winding break of the coil.

### Solution to Problem

In order to achieve the object of the invention, there is provided a rotary electric machine which includes a stator which includes a stator core, a bobbin attached to the stator core, and a coil wound around a winding portion of the bobbin to generate a magnetomotive force, and a rotor provided on an inner peripheral side of the stator. The winding portion includes a regulation portion in an end surface in an axial direction of a rotation shaft of the rotary electric machine to regulate a position of the coil wound around the winding portion.

### Advantageous Effects of Invention

According to the invention, it is possible to provide a rotary electric machine which achieves miniaturization and high power while preventing a winding break of a coil.

Objects, configurations, and effects besides the above description will be apparent through the explanation on the following embodiments.

### BRIEF DESCRIPTION OF DRAWINGS

FIG. 1 is a perspective view of an electric power steering motor 100 according to a first embodiment of the invention.

FIG. 2 is a side view illustrating a state that the electric power steering motor 100 illustrated in FIG. 1 is stored in a housing 1 partially cut off to view a shaft 5.

FIG. 3 is a plan view illustrating a stator core 2 illustrated in FIG. 1 viewed from an axial direction with respect to a rotation shaft of the motor 100.

FIG. 4 is a plan view illustrating a stator 101 illustrated in FIG. 1 viewed from the axial direction with respect to the rotation shaft of the motor 100.

FIG. 5 is a perspective view illustrating a state that adjacent two coils 4 among a plurality of split cores 2a illustrated in FIG. 1 are wound.

FIG. 6 is a diagram for describing a state that one coil among the plurality of split cores 2a illustrated in FIG. 1 is wound.

FIG. 7 is a plan view illustrating one bobbin assembly 73 when viewed from a direction A illustrated in FIG. 5.

FIG. 8 is a diagram for further describing the winding of the coil 4 around a bobbin 3 with reference to the bobbin assembly 73 illustrated in FIG. 7.

FIG. 9 is an enlarged view of the vicinity of a slot 2e with respect to the stator 101 illustrated in FIG. 4.

FIG. 10 is a sectional side view schematically illustrating a case where a projection 46 has a shape having a slope.

### DESCRIPTION OF EMBODIMENTS

Hereinafter, embodiments of the invention will be described with reference to the accompanying drawings. Further, the accompanying drawings and the following explanations illustrate specific embodiments according to the principle of the invention in order to help with understanding of the invention, and the invention is not interpreted in a limited way.

In the following, the description will be given about a rotary electric machine according to the invention using an electric power steering motor as an example which assists the steering of a vehicle. However, it is a matter of course that the invention is applicable even to other rotary electric machines.

### First Embodiment

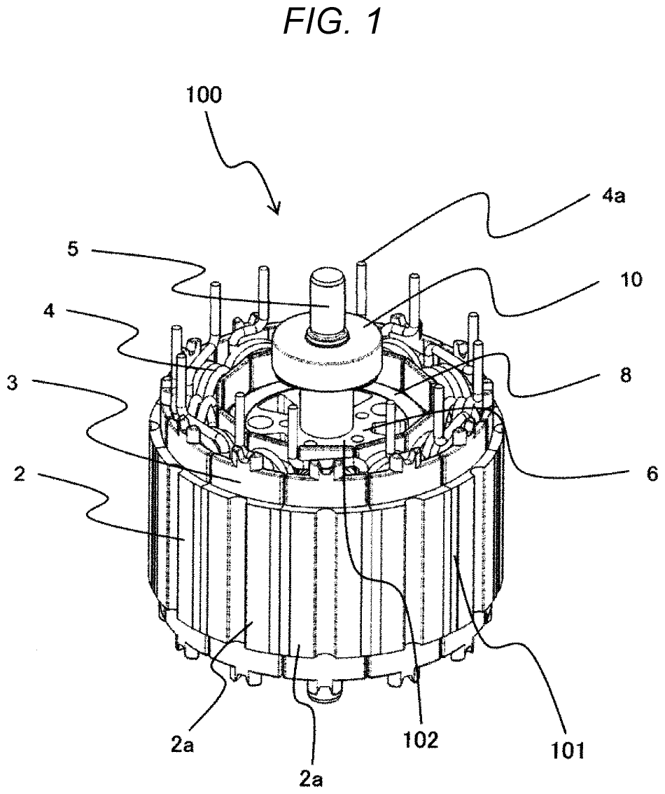

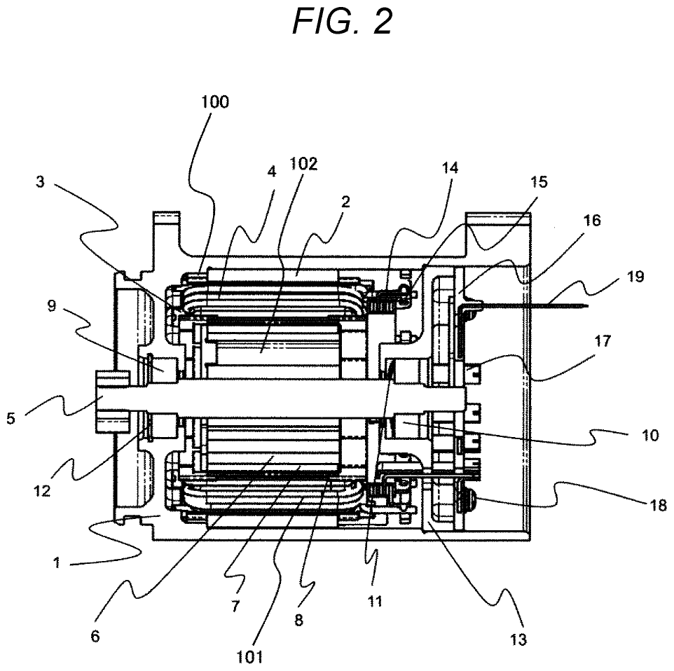

FIG. 1 is a perspective view of an electric power steering motor 100 according to a first embodiment of the invention. FIG. 2 is a side view illustrating a state that the electric power steering motor 100 illustrated in FIG. 1 is stored in a housing 1 partially cut off to view a shaft 5. In FIG. 1, the shaft 5 which is a rotation shaft of the electric power steering motor 100 (hereinafter, simply referred to as “motor 100”) is illustrated as to face in a longitudinal direction. In FIG. 2, the shaft 5 is illustrated as to face in a horizontal direction.

A stator core 2 formed by assembling a plurality of split cores 2a in the circumferential direction is held in a ring shape by welding or without welding on an inner peripheral side of the housing 1, and press-fitted or thermally fitted. In this embodiment, the stator core 2 is configured by 12 split cores 2a. Further, the description in this embodiment is about a case where the stator core 2 is configured by the plurality of split cores 2a, but the invention is not limited thereto. The invention may be applied even to a case where the stator core 2 is not divided but integrated in one body.

A bobbin 3 is attached to the split core 2a of the stator core 2, and a coil 4 is wound around an outer peripheral portion (winding portion) of the bobbin 3 to form a stator 101. A coil lead wire 4a which is a lead wire of the coil 4 is connected to a bus bar terminal 15 which is provided in a bus bar mold 14. The end surface of the bus bar terminal 15 is welded and connected to the end surface of a bus bar terminal 17 which is provided in another bus bar mold 16.

On an inner peripheral side of the stator core 2, a rotor 102 is provided which is configured by the shaft 5, a rotor core 6, a magnet 7, and a magnetic cover 8. The rotor 102 is supported by an F bearing (front bearing) 9 and an R bearing (rear bearing) 10. The F bearing 9 is fixed to the housing 1, and the R bearing 10 is fixed to a cover 13. The cover 13 is provided with a through hole through which the bus bar terminal 15 passes, is connected to the bus bar mold 16 by a screw 18. Further, the bus bar terminal 17 is configured such that the connection of each phase is routed a three-phase output to form U, V, and W three-phase outputs. The three-phase output terminal 19 is supplied with power from an inverter (not illustrated) to rotate the motor 100.

A retaining ring 12 is provided to abut on the F bearing 9 around the shaft 5. A pressurizing spring 11 is provided to abut on the R bearing 10 around the shaft 5.

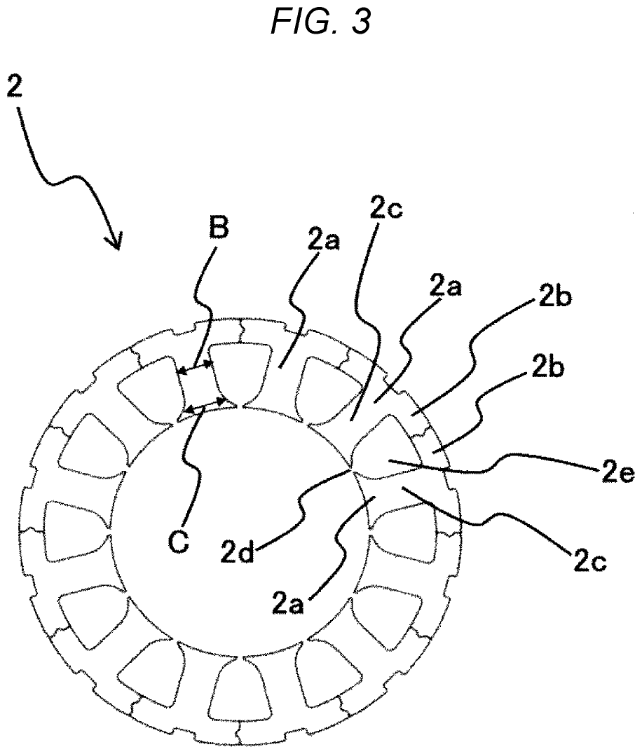

FIG. 3 is a plan view illustrating the stator core 2 illustrated in FIG. 1 viewed from an axial direction with respect to the rotation shaft of the motor 100.

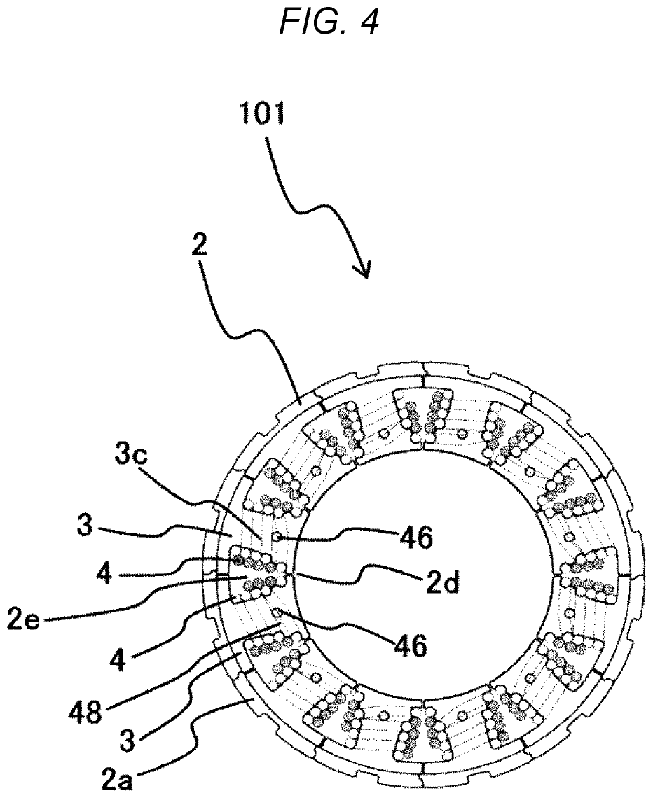

FIG. 4 is a plan view illustrating the stator 101 illustrated in FIG. 1 viewed from the axial direction with respect to the rotation shaft of the motor 100.

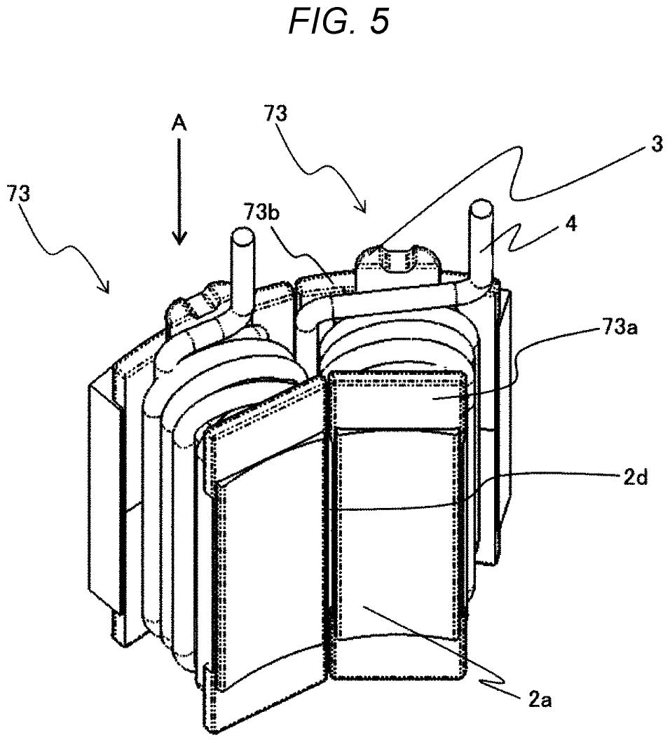

FIG. 5 is a perspective view illustrating a state that adjacent two coils 4 among the plurality of split cores 2a illustrated in FIG. 1 are wound. A state that the bobbin 3 is assembled to the split core 2a and the coil 4 is wound is called a bobbin assembly 73.

As described above, the stator core 2 is disposed on the outermost peripheral side in the housing 1. The stator core 2 is configured by a T-shaped split core 2a (see FIG. 3). Each split core 2a includes a core teeth portion 2c which is wound by the coil 4 through a winding portion 3c (see FIG. 4) of the bobbin 3. The split cores 2a are connected to each other by welding with a core back portion 2b. A slot 2e is formed between the core teeth portion 2c of a certain split core 2a and the core teeth portion 2c of the adjacent split core 2a. The winding portion 3c of the bobbin 3 is formed between an inner diameter side flange 73a of the bobbin 3 and an outer diameter side flange 73b of the bobbin 3. On the inner peripheral side of the stator 101, the split cores 2a and the inner diameter side flanges 73a of the adjacent bobbin assemblies 73 do not abut but form a slot opening 2d.

As illustrated in FIG. 3, the core teeth portion 2c of the split core 2a is formed such that a width C on the inner side of the radial direction with respect to the rotation shaft of the motor 100 is larger than a width B on the outer side of the radial direction to be in a divergent shape. With such a shape, a rotation torque of the motor 100 can be increased still more. In addition, the shape of the core teeth portion 2c of the split core 2a becomes large, as illustrated in FIG. 3, in a smooth curve from the width B on the outer side of the radial direction with respect to the rotation shaft of the motor 100 to the width C on the inner side of the radial direction, so that a magnetic saturation occurs hardly.

More specifically, as illustrated in FIG. 4, a projection 46 protruding in the axial direction is provided in the end surface in the axial direction (hereinbelow, referred to as “rotation-axis-direction end surface”) 48 with respect to the rotation shaft of the motor 100 in the surface of the winding portion 3c of the bobbin 3. The projection 46 corresponds to a regulation portion which regulates a position of the coil 4 wound around the winding portion 3c. Further, the projection 46 may be provided in both end surfaces in the axial direction with respect to the rotation shaft of the motor 100 in the surface of the winding portion 3c of the bobbin 3, or may be provided only in one end surface. The shape of the projection 46 may a cylindrical shape protruding in the axial direction, a semispherical shape protruding in the axial direction, a conical shape protruding in the axial direction or, besides a circular shape, any shape such as a triangular shape or other polygonal shape protruding in the axial direction.

In addition, as illustrated in FIG. 4, the inside of the slot 2e can be viewed from the slot opening 2d. With this configuration, it can be checked that the coil 4 wound around a certain core teeth portion 2c of the split core 2a and the coil 4 wound around the core teeth portion 2c of the adjacent split core 2a do not abut in the slot 2e (for example, no winding break occurs) through the slot opening 2d.

Further, in this embodiment, a concentrated winding is employed. As illustrated in FIG. 5, the core teeth portions 2c of two split cores 2a are configured to be continuously wound by one coil 4 in a concentrated manner. However, the invention may be applied to other windings, for example, a distributed winding.

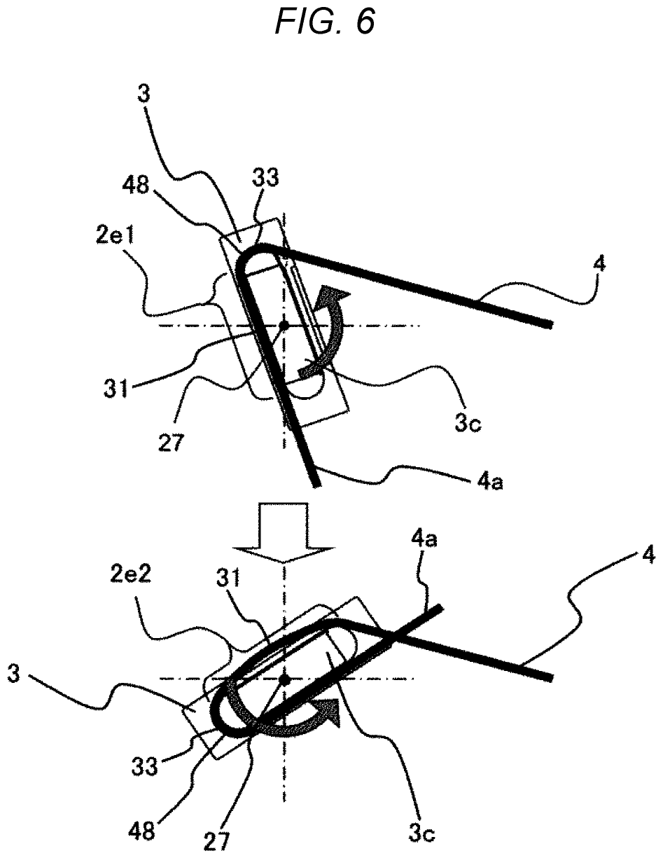

FIG. 6 is a diagram for describing a state that one coil among the plurality of split cores 2a illustrated in FIG. 1 is wound.

The bobbin 3 of FIG. 6 illustrates a state of being assembled to the split core 2a. At this time, the winding portion 3c of the bobbin 3 covers the core teeth portion 2c of the split core 2a. When the coil 4 is wound around the bobbin 3, the coil lead wire 4a is disposed to protrude from the slot 2e in the axial direction of the rotation shaft of the motor 100, the coil 4 is supplied while rotating the bobbin 3 about a rotation shaft 27 which is the rotation shaft to rotate the bobbin 3, and the coil 4 is wound around the winding portion 3c of the bobbin 3. In FIG. 6, the bobbin 3 is rotated in a counterclockwise direction about the rotation shaft 27. However, the bobbin 3 may be rotated in a clockwise direction to wind the coil 4. The rotation shaft 27 may be located at a gravity center of the bobbin 3 for example.

A portion connected to the coil lead wire 4a among the coils 4 becomes a conductive portion 31 which is stored in one slot 2e1 of both sides of the split core 2a. The coil 4 led out from the one slot 2e1 becomes a jumper wire 33 reaching the rotation-axis-direction end surface 48. Then, the coil 4 becomes the conductive portion 31 which is stored in the other slot 2e2 of both sides of the split core 2a. The jumper wire 33 is a wire to connect the conductive portion 31 stored in the slot 2e1 and the conductive portion 31 stored in the slot 2e2.

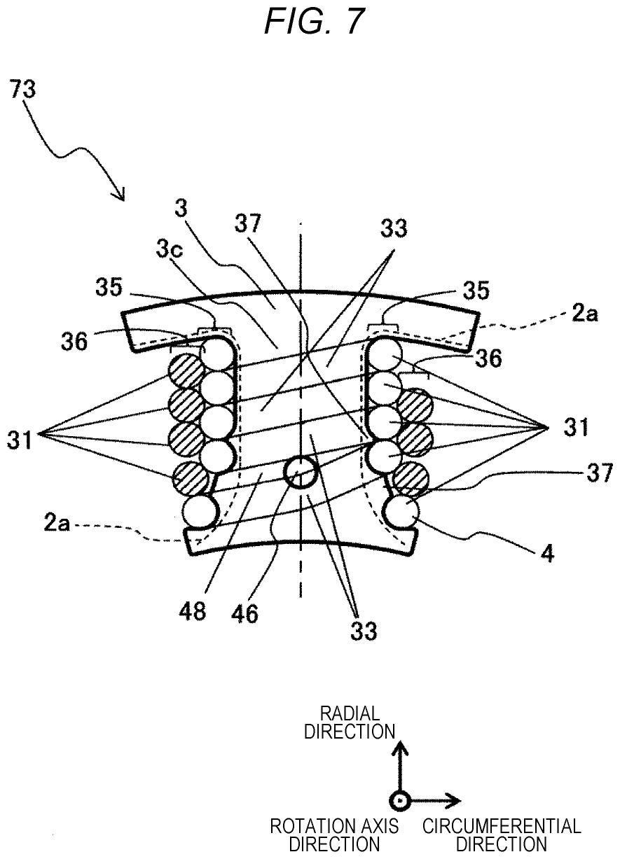

FIG. 7 is a plan view illustrating one bobbin assembly 73 when viewed from a direction A illustrated in FIG. 5.

In FIG. 7, the contour of the split core 2a in the bobbin 3 is shown with a dotted line.

In addition, in FIG. 7, the jumper wire 33 is illustrated passing through in order to clearly show the projection 46 provided in the rotation-axis-direction end surface 48. In FIG. 7, the coil 4 is wound around the bobbin 3 in a right direction when viewed from the upper side of FIG. 7.

As described above, a portion stored in the slot 2e among the coils 4 wound around the winding portion 3c of the bobbin 3 is called the conductive portion 31, and the portion outside of the slot 2e is called the jumper wire 33. The conductive portion 31 has a function of generating a magnetomotive force by making the current flow. The jumper wire 33 has almost no function of generating the magnetomotive force but has a function of electrically connecting the conductive portions 31. When the coil 4 is wound around the winding portion 3c, the winding proceeds from the outer diameter side to the inner diameter side in the radial direction with respect to the rotation shaft of the motor 100. In the winding portion 3c, first, a first layer coil 35 is wound, and subsequently a second layer coil 36 is wound.

Further, in this embodiment, the projection 46 is integrally formed with the bobbin 3 to reduce the number of components, but the invention is not limited thereto. The projection 46 may be formed separately from the bobbin 3.

Recently, miniaturization and high power are required for the rotary electric machine such as the motor 100. In order to achieve miniaturization and high power, the coil 4 is necessarily reduced in electric resistance. In order to reduce the electric resistance, a cross section of the conductive portion 31 of the coil 4 becomes larger. In a constant coil space, there is a need to wind more conductive portion 31.

If a distance between the coil 4 wound around the core teeth portion 2c and the coil 4 wound around the adjacent core teeth portion 2c (that is, an insulation distance) is not sufficient when a potential difference caused between the adjacent core teeth portions 2c in concentrated winding coils of plural phases is taken into consideration, the coils 4 may abut on each other, and it becomes difficult to secure sufficient insulation. If more conductive portion 31 is stored in the slot 2e (that is, the number of times of winding the coil 4 is increased), a distance between the coils 4 is reduced. In some cases, the coils 4 may abut on each other.

When the coil 4 is wound around the winding portion 3c, a balance of tension distribution in winding which operates on the jumper wire 33 is lost, and as a result the winding break may occur. The conductive portions 31 each are stored in the slot 2e at the same position in the radial direction with respect to the rotation shaft of the motor 100. Therefore, the winding break hardly occurs in the conductive portion 31.

With this regard, in the jumper wire 33, the winding portion 3c is rotated obliquely from the outer diameter direction to the inner diameter direction (from the inner diameter direction to the outer diameter direction in a case where the winding is made from the inner diameter side to the outer diameter side in the radial direction with respect to the rotation shaft of the motor 100 when the coil 4 is wound around the winding portion 3c) in order to connect the conductive portion 31 of the slot 2e1 to the conductive portion 31 of the slot 2e2. Therefore, the balance of tension distribution in winding is easily changed. In other words, it is hard to keep a constant winding tension (the tension of the coil 4) when winding the coil 4. Therefore, the winding break occurs often about the jumper wire 33. In addition, recently, the electric resistance of the coil 4 is lowered, the efficiency of the motor 100 is increased by increasing the thickness of the coil 4. However, as the thickness of the coil 4 is increased, the winding tension is necessarily set to be high. In this case, the winding tension is hardly kept constant, and thus the winding break easily occurs.

In this embodiment, as illustrated in FIG. 7, the projection 46 as a regulation portion to regulate the position of the jumper wire 33 is provided in the rotation-axis-direction end surface 48 of the winding portion 3c. The projection 46 is provided at the center of the width of the rotation-axis-direction end surface 48 in the circumferential direction with respect to the rotation shaft of the motor 100. The projection 46 is located at the center in the length direction of the jumper wire 33. Part of the jumper wire 33 and the projection 46 abut. With this configuration, the balance of the tension distribution when winding the coil 4 can be kept constant, and the winding break can be suppressed. The regulation portion to regulate the position of the jumper wire 33 is not limited to the projection 46, and may be formed in a groove, a plurality of irregularities as long as the position of the jumper wire 33 is regulated.

Further, in this embodiment, projections 37 protruding in the circumferential direction are provided in the end surfaces (that is, the walls of the slot 2e) on both sides in the circumferential direction with respect to the rotation shaft of the motor 100 in the surface of the winding portion 3c of the bobbin 3, so that the position of the conductive portion 31 in the slot 2e is regulated, the position of the conductive portion 31 is more stabilized, and the winding break hardly occurs. The projection 37 may be not provided in order to secure a sufficient coil space in the slot 2e. However, the winding position of the coil 4 can be more securely regulated with the cooperation of the projection 46 and the projection 37. The projection 46 and the projection may be linked. The regulation of the position of the conductive portion 31 is not limited to the configuration using the projection 37, but may be configured by a projection, a groove, or a plurality of irregularities which are provided on both sides or one side in the circumferential direction in the surface of the winding portion 3c of the bobbin 3.

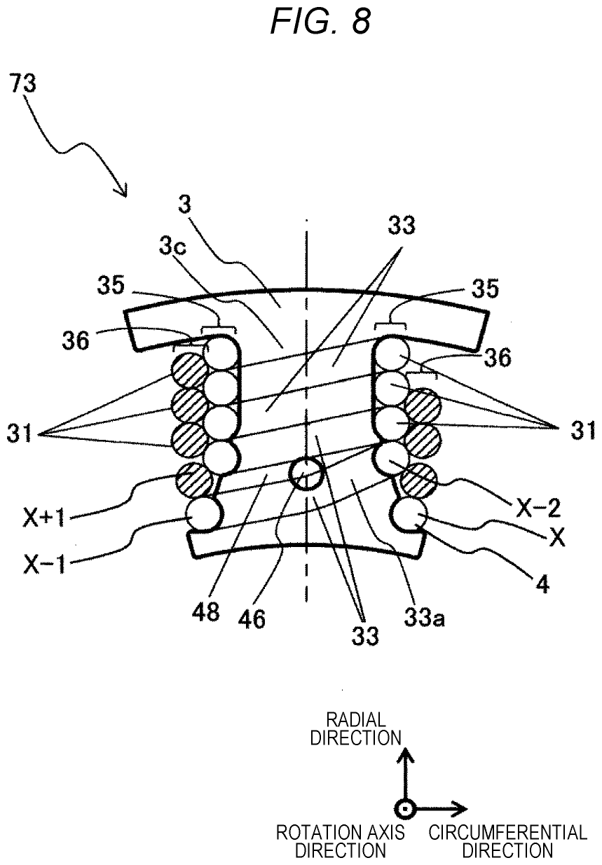

FIG. 8 is a diagram for describing the winding of the coil 4 around the bobbin 3 with reference to the bobbin assembly 73 illustrated in FIG. 7. In FIG. 8, the bobbin assembly 73 similar to that of FIG. 7 is illustrated, and a winding order of the coil 4 is indicated.

The winding break occurs often in a folding from the first layer coil 35 to the second layer coil 36, that is, a portion from the finally-wound conductive portion 31 (winding order (X)) of the first layer to the first-wound conductive portion 31 (winding order (X+1)) of the following second layer. This is caused by a positional deviation of a jumper wire 33a which links the conductive portion 31 corresponding to the winding order (X−2) of the previous winding and the conductive portion 31 corresponding to the winding order (X−1). The jumper wire 33a on a side of the conductive portion 31 corresponding to the winding order (X−1) is easily deviated upward in FIG. 8 in the radial direction with respect to the rotation shaft of the motor 100. Then, the conductive portion 31 corresponding to the winding order (X−1) is also deviated upward. The conductive portion 31 corresponding to the winding order (X+1) is located on the left side in FIG. 8 in the circumferential direction with respect to the rotation shaft of the motor 100, and the winding break comes to easily occur.

In this embodiment, in order to resolve the occurrence of the winding break, the position of the jumper wire 33a which links the conductive portion 31 corresponding to the winding order (X−2) and the conductive portion 31 corresponding to the winding order (X−1) is regulated in the radial direction with respect to the rotation shaft of the motor 100 by providing the projection 46 in the bobbin 3.

Since the jumper wire 33a abuts on the projection 46, the position of the conductive portion 31 corresponding to the winding order (X−1) of the jumper wire 33a is regulated downward in FIG. 8 in the radial direction with respect to the rotation shaft of the motor 100. With this configuration, the position of the conductive portion 31 corresponding to the winding order (X−1) is also regulated downward, and the conductive portion 31 corresponding to the winding order (X+1) is stored on the right side in FIG. 8 in the circumferential direction with respect to the rotation shaft of the motor 100, so that the winding break does not occur.

In addition, the conductive portion 31 (or the second layer coil 36) corresponding to the winding order (X+1) is disposed to abut on the upper side in FIG. 8 of the conductive portion 31 corresponding to the winding order (X−1). The jumper wire 33 and the conductive portion 31 come into tight contact with each other, so that it is possible to suppress the positional deviation of the coil 4.

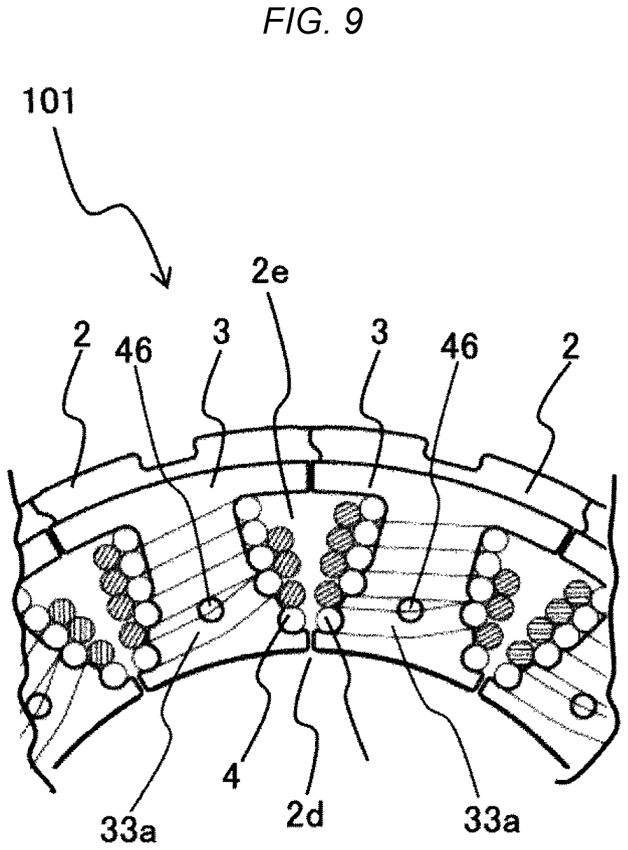

FIG. 9 is an enlarged view of the vicinity of the slot 2e with respect to the stator 101 illustrated in FIG. 4.

In this embodiment, the jumper wire 33a is bent concavely toward the slot opening 2d about the projection 46. In other words, the jumper wire 33a which is a wire abutting on the projection 46 among the jumper wires 33 is bent such that the abutting position of the projection 46 moves to the inner diameter side in the radial direction with respect to the rotation shaft of the motor 100.

With such a configuration, a contact area between the jumper wire 33a and the projection 46 is increased compared to the case of no bending, and the operation of regulating the position of the jumper wire 33a can be increased. Further, the positional deviation of the jumper wire 33a and the winding break can be securely prevented.

Hereinbelow, the projection 46 provided in the bobbin 3 will be further described.

In this embodiment, as illustrated in FIG. 7, the projection 46 is provided at the center of the width of the rotation-axis-direction end surface 48 in the circumferential direction with respect to the rotation shaft of the motor 100. With this configuration, in both cases that the winding direction of the coil 4 is a right direction and a left direction, the common bobbin 3 can be used. For example, in a case where the projection 46 is shifted to the left side of the width of the rotation-axis-direction end surface 48 in the circumferential direction with respect to the rotation shaft of the motor 100, the position of the coil 4 can be regulated as long as the winding direction of the coil 4 is the right direction. If the winding direction of the coil 4 is the left direction, the position of the coil 4 may be not regulated. However, the invention is not limited to that the projection is provided at the center of the rotation-axis-direction end surface 48. The projection 46 may be provided to be shifted to the left side of the width of the rotation-axis-direction end surface 48 in the circumferential direction with respect to the rotation shaft of the motor 100, or may be provided to be shifted to the right side of the width of the rotation-axis-direction end surface 48 in the circumferential direction with respect to the rotation shaft of the motor 100. Further, the projection 46 may be provided at an appropriate position (that is, a position where the position of the coil 4 can be regulated) according to the direction or the number of times of winding the coil 4.

### Second Embodiment

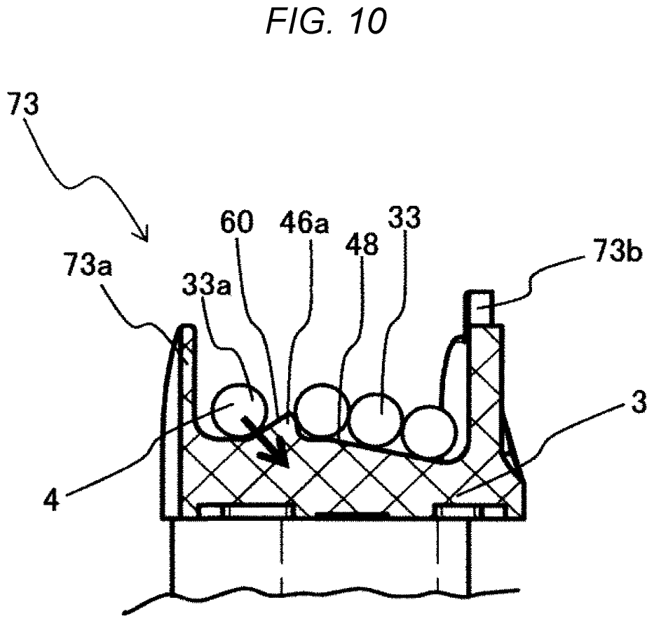

Further, the shape of the projection 46 may be formed as illustrated in FIG. 10.

FIG. 10 is a sectional side view schematically illustrating a case where the projection 46 according to a second embodiment of the invention has a shape having a slope. In FIG. 10, the rotation-axis-direction end surface 48 is illustrated between the inner diameter side flange 73a and the outer diameter side flange 73b. The same configurations as those of the first embodiment are attached with the same symbol, and the detailed description will be omitted. In FIG. 10, the coil 4 is wound only by one layer.

A projection 46a of this embodiment has a configuration corresponding to the regulation portion which regulates the position of the coil 4 similarly to the projection 46 of the first embodiment, and includes a slope 60 in the surface abutting on the coil 4.

A winding tension added to the jumper wire 33a operates on the projection 46a which abuts on the jumper wire 33a. As the abutting area (contact area) is increased, the position of the jumper wire 33a can be regulated more securely. In this embodiment, the slope 60 is provided in a portion abutting on the jumper wire 33a which is part of the projection 46a, so that the contact area can be expanded. Therefore, it is possible to regulate the position of the jumper wire 33a more securely.

Further, a notch (not illustrated) is provided instead of the slope 60 in a portion abutting on the jumper wire 33a which is part of the projection 46a, so that the contact area is expanded in a notched place and the projection 46a, and the position of the jumper wire 33a may be regulated more securely.

In addition, the position of the coil 4 may be smoothly regulated by making a place abutting on the coil 4 in the projection 46a like the slope 60.

### Third Embodiment

Further, in the first embodiment, the projection 46 is provided in the bobbin 3, the winding position of the coil 4 is regulated by the projection 46. However, the invention is not limited to the above configuration. For example, a tool may be provided at the position of the projection 46 to press the coil 4 using the tool, so that the winding position of the coil 4 may be regulated.

### <Notes 1>

Further, the invention described above is:

1.

A rotary electric machine (for example, the motor 100) includes a stator (for example, the stator 101) which includes a stator core (for example, the stator core 2), a bobbin (for example, the bobbin 3) attached to the stator core, and a coil (for example, the coil 4) wound around a winding portion (for example, the winding portion 3c) of the bobbin to generate a magnetomotive force, and a rotor (for example, the rotor 102) provided on an inner peripheral side of the stator. The winding portion includes a regulation portion (for example, the projection 46) in an end surface (for example, the rotation-axis-direction end surface 48) in an axial direction of a rotation shaft (for example, the shaft 5) of the rotary electric machine to regulate a position of the coil wound around the winding portion.

Therefore, it is possible to provide a rotary electric machine which achieves miniaturization and high power while preventing the winding break of the coil.

In addition, in a case where the rotary electric machine is a motor, it is possible to provide a motor which achieves miniaturization and high power.

In addition, with the miniaturization and high power, it is possible to improve a performance of mounting the rotary electric machine in a system.

In addition, since the winding break hardly occurs, it is possible to improve reliability by securing electric insulation between phases of the coil.

In addition, the invention is:

2.

In the rotary electric machine according to 1, the stator core includes a plurality of core teeth portions (for example, the core teeth portion 2c), and a core back portion (for example, the core back portion 2b) which connects the plurality of core teeth portions in a circumferential direction of the rotation shaft. The winding portion is disposed to cover the core teeth portion. The stator includes a plurality of slots (for example, the slot 2e). The coil is a concentrated winding coil which is wound at least two layers around the winding portion. The coil is configured by a conductive portion (for example, the conductive portion 31) disposed in the slot, and a jumper wire (for example, the jumper wire 33) which links the conductive portion. The regulation portion is a projection which protrudes in the axial direction. The projection abuts on part (for example, the jumper wire 33a) of the jumper wire of a first layer winding (for example, the first layer coil 35) which is a winding of a first layer to regulate a position in a radial direction of the rotation shaft of the jumper wire.

Therefore, it is possible to prevent the winding break which is caused by the positional deviation of the jumper wire.

In addition, the invention is:

3.

In the rotary electric machine according to 2, when an order of a winding of the conductive portion finally wound around the core teeth portion in the first layer windings is set to (x), part of the jumper wire linking the conductive portion of the winding order (x−2) and the conductive portion of the winding order (x−1) abuts on the projection so as to regulate the position in the radial direction of the jumper wire. The conductive portion corresponding to the winding order (x+1) disposed adjacent to the conductive portion of the winding order (x−1) or a second layer winding (for example, the second layer coil 36) is provided.

Therefore, it is possible to prevent the winding break caused by the positional deviation of the jumper wire by regulating the position of the jumper wire which is easily deviated in position among the plurality of jumper wires.

In addition, the invention is:

4.

In the rotary electric machine according to 2, a wire (for example, the jumper wire 33a) abutting on the projection among the jumper wires is bent such that an abutting position of the projection moves to an inner diameter side in the radial direction.

Therefore, it is possible to increase the contact area between the jumper wire and the projection, and to increase the regulation on the position of the jumper wire.

In addition, the invention is:

5.

In the rotary electric machine according to 2, the projection is provided at a center position in the circumferential direction of the core teeth portion.

Therefore, even in a case where the coil is wound in a right direction or in a left direction, the same bobbin can be used in common, and a manufacturing cost can be reduced.

In addition, the invention is:

6.

In the rotary electric machine according to 2, a slope (for example, the slope 60) or a notch is provided in an outer peripheral surface of the projection where the jumper wire abuts.

Therefore, it is possible to increase the contact area between the jumper wire and the projection, and to increase the regulation on the position of the jumper wire.

Further, the invention is not limited to the above embodiments, but various modifications may be contained. For example, the above-described embodiments of the invention have been described in detail in a clearly understandable way, and are not necessarily limited to those having all the described configurations.

In addition, some of the configurations of a certain embodiment may be replaced with the configurations of the other embodiments, and the configurations of the other embodiments may be added to the configurations of the subject embodiment.

In addition, some of the configurations of each embodiment may be added, omitted, or replaced with other configurations.

In addition, the invention may include a combination of each element of the above-described embodiments.

### INDUSTRIAL APPLICABILITY

The invention can be used as a brushless motor used in an electric power steering motor, an in-vehicle rotary electric machine such as various types of generators, a bobbin structure of a motor system, and a structure of coil winding.

### REFERENCE SIGNS LIST

100 electric power steering motor
101 stator
102 rotor
1 housing
2 stator core
2a split core
2b core back portion
2c core teeth portion
2d slot opening
2e slot
2e1 slot
2e2 slot
3 bobbin
3c winding portion
4 coil
5 shaft
6 rotor core
7 magnet
8 magnetic cover
9 F bearing
10 R bearing
11 pressurizing spring
12 retaining ring
13 cover
14 bus bar mold
15 bus bar terminal
16 bus bar mold
17 bus bar terminal
18 screw
19 three-phase output terminal
31 conductive portion
33 jumper wire
33a jumper wire
35 first layer coil
36 second layer coil
37 projection
46 projection
48 rotation-axis-direction end surface
60 slope
73 bobbin assembly
73a inner diameter side flange
73b outer diameter side flange

1. A rotary electric machine, comprising:
a stator which includes a stator core, a bobbin attached to the stator core, and a coil wound around a winding portion of the bobbin to generate a magnetomotive force; and
a rotor provided on an inner peripheral side of the stator,
wherein the winding portion includes a regulation portion in an end surface in an axial direction of a rotation shaft of the rotary electric machine to regulate a position of the coil wound around the winding portion.

2. The rotary electric machine according to claim 1, wherein
the stator core includes a plurality of core teeth portions, and a core back portion which connects the plurality of core teeth portions in a circumferential direction of the rotation shaft,
the winding portion is disposed to cover the core teeth portion,
the stator includes a plurality of slots,
the coil is a concentrated winding coil which is wound at least two layers around the winding portion,
the coil is configured by a conductive portion disposed in the slot, and a jumper wire which links the conductive portion,
the regulation portion is a projection which protrudes in the axial direction, and
the projection abuts on part of the jumper wire of a first layer winding which is a winding of a first layer to regulate a position in a radial direction of the rotation shaft of the jumper wire.

3. The rotary electric machine according to claim 2, wherein
when an order of a winding of the conductive portion finally wound around the core teeth portion in the first layer windings is set to (x), part of the jumper wire linking the conductive portion of the winding order (x−2) and the conductive portion of the winding order (x−1) abuts on the projection so as to regulate the position in the radial direction of the jumper wire, and
the conductive portion corresponding to the winding order (x+1) disposed adjacent to the conductive portion of the winding order (x−1) or a second layer winding is provided.

4. The rotary electric machine according to claim 2, wherein a wire abutting on the projection among the jumper wires is bent such that an abutting position of the projection moves to an inner diameter side in the radial direction.

5. The rotary electric machine according to claim 2, wherein the projection is provided at a center position in the circumferential direction of the core teeth portion.

6. The rotary electric machine according to claim 2, wherein a slope or a notch is provided in an outer peripheral surface of the projection where the jumper wire abuts.
